(19) United States
(12) Patent Application Publication
(10) Pub. No.: US 2021/0335539 A1
(43) Pub. Date: Oct. 28, 2021

(54) ADDITIVE MANUFACTURING OF MAGNET ARRAYS

(71) Applicant: Ford Global Technologies, LLC, Dearborn, MI (US)

(72) Inventors: Michael W. Degner, Novi, MI (US); Wanfeng Li, Novi, MI (US)

(73) Assignee: Ford Global Technologies, LLC, Dearborn, MI (US)

(21) Appl. No.: 17/371,988

(22) Filed: Jul. 9, 2021

Related U.S. Application Data
(63) Continuation of application No. PCT/US2019/012818, filed on Jan. 9, 2019.

(51) Int. Cl. H01F 41/02; H02K 1/02; B33Y 10/00; B22F 10/16; B22F 10/28; C22C 38/00

(52) U.S. Cl. CPC H01F 41/0273; H02K 1/02; B33Y 10/00; B33Y 80/00; B22F 10/28; C22C 38/005; B22F 10/16

(57) ABSTRACT

A method of forming a magnet is provided. The method includes disposing an anisotropic magnetic powder and a binder within a bed, the anisotropic magnetic powder having a defined magnetization direction. An energy beam selectively melts the binder such that the anisotropic magnetic powder forms a permanent magnet with the defined magnetization direction. The energy beam is a laser beam, a microwave beam and the like.

### CROSS-REFERENCE TO RELATED APPLICATIONS

This application is a continuation of International Application No. PCT/US2019/012818, filed on Jan. 9, 2019. The disclosure of the above application is incorporated herein by reference.

### FIELD

The present disclosure relates to manufacturing magnets, and particularly, to manufacturing magnet arrays.

### BACKGROUND

The statements in this section merely provide background information related to the present disclosure and may not constitute prior art.

Historically permanent magnets have been used in a wide variety of applications such as energy conversion, information technology, medical equipment, toys, and wave guides. Progresses in advanced permanent magnets have greatly extended permanent magnet applications concurrently with marked efficiency improvements. For many applications, high permeability materials are combined with permanent magnets to modulate the magnitude and distribution of the magnetic flux. Usually, the permanent magnets are homogenous and regular in shape. In other applications, the magnetic fields and their distribution are modified by altering the arrangement, shape, and size of permanent magnets. For example, magnet arrays such as a Halbach array produce a strong concentrated and spatially periodic magnetic field. Also, are other types (non-Halbach) of magnet arrays enable generation of strong magnetic fields and are combinable with conventional magnetic designs to improve performance or design flexibility. However, manufacturing such arrays can be difficult since designing and machining magnets with complex shapes is required.

The present disclosure addresses the issues of designing and manufacturing magnet arrays with complex shapes and customized magnetization directions, among other issues related to the manufacture of magnet arrays.

### SUMMARY

This section provides a general summary of the disclosure and is not a comprehensive disclosure of its full scope or all of its features.

In one form of the present disclosure, a method of forming a magnet includes disposing an anisotropic magnetic powder with a defined magnetization direction and a binder within a bed and operating an energy beam, e.g., an electron beam, laser beam, or a microwave beam, to selectively melt the binder such that the anisotropic magnetic powder forms a permanent magnet with the defined magnetization direction. In some aspects of the present disclosure, a surface layer of the anisotropic magnetic powder is also melted.

In some aspects of the present disclosure, the binder is a binder powder mixed with the anisotropic magnetic powder. In the alternative, or in addition to, the binder is a binder layer disposed on the anisotropic magnetic powder. For example, the anisotropic magnetic powder and the binder in the bed may be in the form of core-shell particles with the anisotropic magnetic powder coated with the binder. In such aspects, the binder is an epoxy, a ceramic, or a metal alloy with a melting point less than 800° C. For example, in some aspects of the present disclosure the binder is a (Nd_{(1-x-y-z)}PrₓDy_{y}Tb_{z})ₐ(Cu_{(1-u-v-w)}(AlᵤZnᵥGa_{w})_{b}) alloy. In such aspects the anisotropic magnetic powder is a Nd—Fe—B magnetic powder. Also, the packing density of the anisotropic magnetic powder and the binder may be increased by sonicating, tapping or rolling the bed.

In some aspects of the present disclosure, an external magnetic field is applied to the anisotropic magnetic powder in the bed to define the magnetization direction. For example, in some aspects of the present disclosure the magnetization direction is defined by applying a pulsating external magnetic field to the bed of anisotropic magnetic powder and binder. In the alternative, the magnetization direction is defined by applying a DC external magnetic field on the bed of anisotropic magnetic powder and binder.

In some aspects of the present disclosure, the method further includes forming a magnet array comprising a plurality of permanent magnets. In such aspects each of the plurality of permanent magnets has a unique defined magnetization direction different than the defined magnetization direction of the other permanent magnets. For example, the magnet array can be a Halbach array. Also, at least one electric machine with the Halbach array or another type or magnet array can be included. In some other aspects, the array is continuous with gradual varying magnetization directions. For example, the magnet array can be a ring where the magnetization direction varies gradually.

In another form of the present disclosure, a method of forming a plurality of permanent magnets includes disposing an anisotropic magnetic powder and a binder in a bed. The anisotropic magnetic powder has a defined magnetization direction and an energy beam is operated to selectively melt the binder such that the anisotropic magnetic powder forms a permanent magnet with the defined magnetization direction. The method includes forming additional permanent magnets such that a magnet array is formed with each of the permanent magnets having a unique magnetization direction and/or the magnetization direction inside the array forms a certain distribution.

In some aspects of the present disclosure, operating the energy beam includes a first scan of the energy beam to selectively melt the binder such that the anisotropic powders are held in a fixed position and a second scan of the energy beam to selectively melt a surface layer of the anisotropic magnetic powder. In such aspects, the surface layer of the anisotropic magnetic powder has a cast or solidification microstructure.

In yet another form of the present disclosure, a method of forming a magnet array includes the steps of: (a) aligning a magnetization direction of a plurality of anisotropic magnetic particles in an anisotropic magnetic powder-binder mixture; (b) selectively melting a binder in the anisotropic powder-binder mixture using an energy beam such that the plurality of anisotropic magnetic particles are bonded together to form a permanent magnet with the aligned magnetization direction; and repeating steps (a) and (b) such that a magnet array with a plurality of permanent magnets is formed and each of the permanent magnets has a unique magnetization direction different than the magnetization direction of the other permanent magnets and/or the magnetization direction of the permanent magnet varies gradually from layer to layer. In some aspects of the present disclosure, the energy beam is a microwave beam and the microwave beam selectively melts the binder and a surface layer of the plurality of anisotropic magnetic particles in the anisotropic magnetic powder-binder mixture.

Further methods and areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically depicts a method and an exemplary apparatus for additive manufacturing a magnet and/or a magnet array;

FIG. 2A is an enlarged view of section 2 in FIG. 1 schematically depicting an exemplary magnetic powder and binder according to the teachings of the present disclosure;

FIG. 2B schematically depicts alignment of the magnetization direction of the magnetic powder in FIG. 2A according to the teachings of the present disclosure;

FIG. 2C schematically depicts melting and solidification of the binder and a surface layer of the magnetic powder in FIG. 2B according to the teachings of the present disclosure;

FIG. 3A is an enlarged view of section 3 in FIG. 1 schematically depicting an exemplary magnetic powder and binder according to the teachings of the present disclosure;

FIG. 3B schematically depicts alignment of the magnetization direction of the magnetic powder in FIG. 3A according to the teachings of the present disclosure;

FIG. 3C schematically depicts melting and solidification of the binder and a surface layer of the magnetic powder in FIG. 3B according to the teachings of the present disclosure;

FIG. 4 schematically depicts a magnet array formed by a method according to the teachings of the present disclosure;

FIG. 5 schematically depicts a magnet array formed by a method according to the teachings of the present disclosure;

FIG. 6 schematically depicts a magnet array formed by a method according to the teachings of the present disclosure;

FIG. 7A schematically depicts the rotor structure of a variable flux electric machine;

FIG. 7B schematically depicts a conventional magnet with a magnetization direction perpendicular to the surface;

FIG. 7C graphically depicts a demagnetization curve for a conventional permanent magnet;

FIG. 7D schematically depicts a continuous magnet with varying magnetic directions according to the teachings of the present disclosure;

FIG. 8 is a flow diagram for a method of forming a permanent magnet according to the teachings of the present disclosure; and

FIG. 9 is a flow diagram for a method of forming a permanent magnet array according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. Examples are provided to fully convey the scope of the disclosure to those who are skilled in the art. Numerous specific details are set forth such as types of specific components, devices, and methods, to provide a thorough understanding of variations of the present disclosure. It will be apparent to those skilled in the art that specific details need not be employed and that the examples provided herein, may include alternative embodiments and are not intended to limit the scope of the disclosure. In some examples, well-known processes, well-known device structures, and well-known technologies are not described in detail.

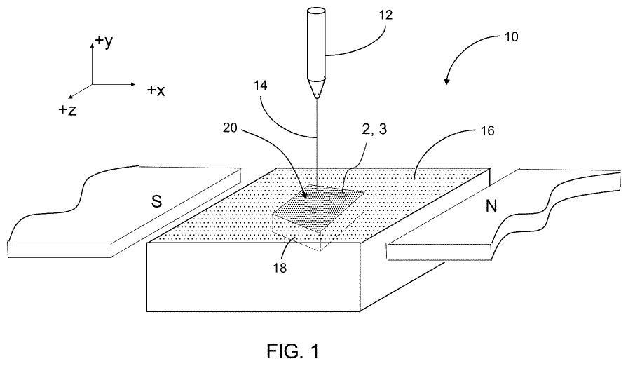

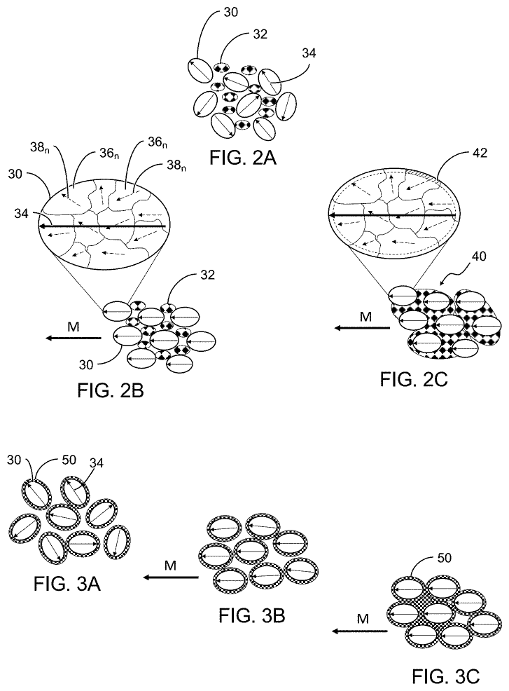

Referring now to FIG. 1, a method 10 for forming a magnet 20 is schematically depicted. The method 10 comprises providing a magnetic field (S, N), an energy beam source 12 (also referred to herein as an energy source) with an energy beam 14, a powder bed 16, and a platform 18 within the powder bed 16. The powder bed 16 (also referred to herein simply as a “bed”) contains anisotropic magnetic powder-binder mixture comprising an anisotropic magnetic powder (also referred to herein simply as a “magnetic powder”) and a binder. As used herein, the term “anisotropic” refers to a magnetic powder or magnetic particle with a net magnetization direction, i.e., the sum of the magnetization vectors of the magnetic powder or magnetic particle is not equal to zero. The particles can be single crystalline or polycrystalline with an easy magnetic axis of each grain substantially parallel to each other instead of being randomly distributed. As used herein, the phrase “easy magnetic axis” refers to the direction inside a grain, particularly a magnetic grain, along which a small applied magnetic field is sufficient to reach its saturation magnetization. In some aspects of the present disclosure, and with reference to FIG. 2A, the bed 16 contains magnetic particles 30 (also referred to herein as magnet particles, magnet powders, and magnetic powders) and binder particles 32. Each of the magnetic particles has a magnetization direction 34. In other aspects of the present disclosure, and with reference to FIG. 3A, the bed 16 contains magnetic particles 30 with a binder coating 50. In still other aspects of the present disclosure, the bed 16 contains magnetic particles 30 and binder particles 32 (FIG. 2A) and magnetic particles 30 with the binder coating 50 (FIG. 3A).

The magnetic particles 30 and binder particles 32 and/or the particles 30 with the binder coating 50 within the bed 16 are oriented such that at least a portion of a layer of the bed 16 has a defined magnetization direction as schematically depicted in FIGS. 2B and 3B. For example, the platform 18 is positioned within the bed 16 such that a layer of the bed 16 is positioned on and between the platform 18 and the energy beam source 12. Also, the magnetic field (S, N) is applied to the bed 16 such that a magnetization direction 34 of each of the magnetic particles 30 is aligned along a defined magnetization direction ‘M’ as schematically depicted in FIGS. 2B and 3B.

After the magnetic field (S, N) is applied to the bed 16, the energy beam 14 scans a desired area across the platform 18 such that a layer of the bed 16 is bonded together. Particularly, and with reference to FIGS. 2B and 2C, the energy beam 14 selectively melts the binder particles 32 which subsequently solidify to form a layer of magnetic particle-binder matrix composite 40. After the layer of magnetic particle-binder matrix composite 40 has been formed, the platform 18 is moved down (−y-direction) a preset distance (i.e., index downward) and another layer of the bed 16 is positioned over (+y-direction) the platform 18 and the layer of magnetic particle-binder matrix composite 40. Then, the energy beam 14 scans another desired area across the platform such that another layer of magnetic particle-binder matrix composite 40 is formed and bonded to the previous layer of the bed 16. This method is repeated such that the magnet 20 is formed layer-by-layer.

In some aspects of the present disclosure, the magnetic particles 30 are single crystal particles. In other aspects of the present disclosure, at least a subset of the magnetic particles 30 are polycrystalline with multiple grains 36ₙ (FIG. 2B), and the polycrystalline grains are anisotropic such that an easy axis of each grain in the particles is parallel or near parallel to the other easy axes of the grains 36ₙ. In other words, each of the grains 36ₙ having a magnetization direction 38ₙ and the magnetization direction 34 of each magnetic particle 30 is the vector sum of the anisotropic magnetization directions 38ₙ of the individual grains 36ₙ.

While the energy beam 14 may only melt the binder particles 32 and/or binder coating 50, in some aspects of the present disclosure the energy beam 14 melts a surface layer 42 of the magnetic particles 30 as schematically depicted in the enlarged inset in FIG. 2C. In such aspects the surface layer 42 solidifies and has a sintered, solidification, and/or cast microstructure that can be observed with optical microscopy, scanning electron microscopy, and the like. For example, the microstructure of the surface layer 42 may comprise dendrites, eutectic solidification structures, and the like. The grains of the surface layer 42 may be columnar or equiaxial with different grain sizes and compositions. In some aspects of the present disclosure, reaction between the binder material and the magnetic powders are favorable for magnetic properties. For example, for a Nd—Fe—B magnet the binder materials can be (Nd_{(1-x-y-z}PrₓDy_{y}Tb_{z})ₐ(Cu_{(1-u-v-w)}(AlᵤZnᵥGa_{w})_{b}) and interface reactions between Nd—Fe—B particles and the (Nd_{(1-x-y-z)}PrₓDy_{y}Tb_{z})ₐ(Cu_{(1-u-v-w)}(AlᵤZnᵥGa_{w})_{b}) material can improve the magnetic properties, particularly the coercivity, of the magnet 20. Also, similar rare earth materials, such as (CeₓLa₁₋ₓ)ₐ(Cu_{(1-u-v-w)}(AlᵤZnᵥGa_{w})_{b}) can be used as a binder material or mixed with (Nd_{(1-x-y-z)}PrₓDy_{y}Tb_{z})ₐ(Cu_{(1-u-v-w)}(AlᵤZnᵥGa_{w})_{b}) to form the binder material.

Regarding melting of the binder and/or surface layer of the magnetic particles, in some aspects of the present disclosure the energy source 12 is a laser source and the energy beam 14 is a laser beam. In other aspects of the present disclosure, the energy source 12 is a microwave source and the energy beam 14 is a microwave beam. It should be understood that other types of energy sources and energy beams may be used and are included in the teachings of the present disclosure. Also, in order to increase the packing density of the magnetic particles 30 and binder particles 32 and/or the particles 30 with the binder coating 50 within the bed 16 and/or within a layer of magnetic particle-binder matrix composite 40, the powder bed 16 can be sonicated, tapped or rolled to increase filling density. Also, non-magnetic powder can be included in the bed 16 to reduce costs while maintaining a desired structure.

It should be understood by adjusting the power and rate of movement (speed) of an energy beam as the energy beam scans the bed 16, the magnetic particles 30 are not completely melted and may not be melted at all. Also, by melting the binder particles 32 and/or the binder coating 50, and optionally the surface layer 42 of the magnetic particles 30, the permanent magnet 20 retains the magnetic properties (orientation, strength among, etc.) of the magnetic particles 30. That is, the power of the energy beam 14 is tuned to mainly react with the binder particles 32 and/or the binder coating 50 and to reduce energy beam—magnetic powder interactions. Thus, the binder particles 32 and/or binder coating 50 are softened, have desired fluidity, and flow into the gaps between the binder particles 32. After the magnet 20 is produced, magnet 20 can be moved and the magnetic field (S, N) and/or the powder bed 16 can be adjusted (e.g., rotated about the y-axis shown in the figures) to manufacture another magnet 20 with a defined magnetization direction M that is not parallel with the defined magnetization direction M of the previously formed magnet 20. Accordingly, the flexibility of additive manufacturing enables a magnet array with a plurality of magnets to be formed and each magnet has a unique magnetization direction M.

The binder particles 32 and/or binder coating 50 may be formed from any known binder material with a melting point below 800° C. Suitable binder materials include epoxies, ceramics and metallic alloys. In some aspects of the present disclosure, the binder material is formed from (Nd_{(1-x-y-z}PrₓDy_{y}Tb_{z})ₐ(Cu_{(1-u-v-w)}(AlᵤZnᵥGa_{w})_{b}), (CeₓLa₁₋ₓ)ₐ (Cu_{(1-u-v-w)}(AlᵤZnᵥGa_{w})_{b}), or a combination thereof, where ‘a’ is greater than ‘b’. In such aspects, the magnetic particles 30 may be Nd—Fe—B magnetic particles. For example, a non-limiting list of magnetic particles 30 is shown in Table 1 below. It should be understood that the magnetic compounds shown in Table 1 are the major and typical magnetic phase of the permanent magnet particles 30, i.e., the magnetic particles 30 may or may not have the same compositions listed in Table 1 since other elements may be present in the magnet powders 30, other phases may be present in the magnet powders 30, and the like.

TABLE 1

| | | | Anisotropy | | |
|---|---|---|---|---|---|
| Magnetic | Saturation | | field | | |
| Compound | magnetization | | kOe | MA/m | Curie temperature |
| Nd₂Fe₁₄B | 16.0 | kG | 73 | 5.81 | 312° C. |
| Sm₂Co₁₇ | 12.5 | kG | 65 | 5.17 | 920° C. |
| SmCo₅ | 11 | kG | 440 | 35.01 | 681° C. |
| Sm₂Fe₁₇N₃ | 15.4 | kG | 280 | 22.28 | 473° C. |
| SrFe₁₂O₁₉ | 4.6 | kG | 19 | 1.51 | 460° C. |

G = Gauss
Oe = Oersted
A/m = Ampere/meter (1 Oe = 79.577 A/m)

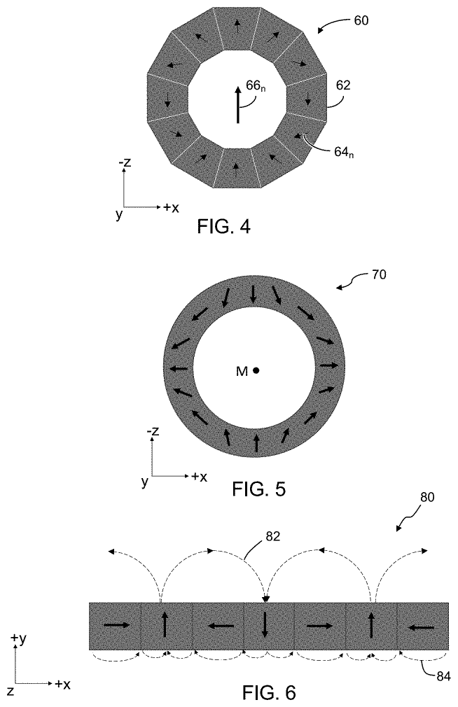

Referring now to FIG. 4, a Halbach array 60 formed according to the teachings of the present disclosure is shown. The Halbach array 60 has a plurality of magnetics 62 (also referred to herein as “magnetic segments”). Each magnetic segment 62 has a magnetization direction 64ₙ and the vector sum of the magnetization directions 64ₙ provide a defined magnetization direction 66ₙ for the Halbach array 60. While the present disclosure is well suited for manufacturing Halbach arrays, other arrays of magnets are also readily manufactured according to the teachings of the present disclosure. For example, a magnet array 70 formed according to the teachings of the present disclosure and with a defined magnetization direction M in the y-direction is schematically depicted in FIG. 5. It should be understood that the magnet array 70 is schematically depicted with no distinct magnet segments as the magnetic fields, energy beam sintering, magnetic powder orientations, among other processes can be modified during manufacture to form the continuous magnet. Also, another Halbach array 80 formed according to the teachings of the present disclosure and with a magnetic field 82 on an upper side (+y-direction) that is large than a magnetic field 84 on a lower side (−y-direction) is schematically depicted in FIG. 6.

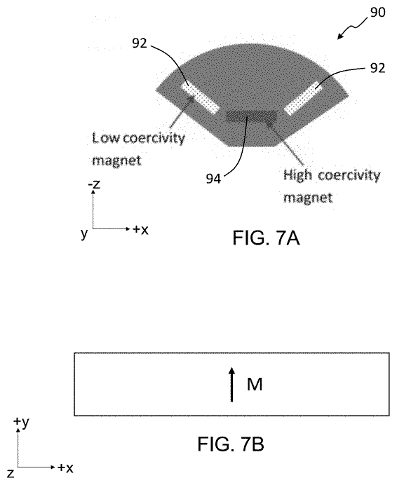

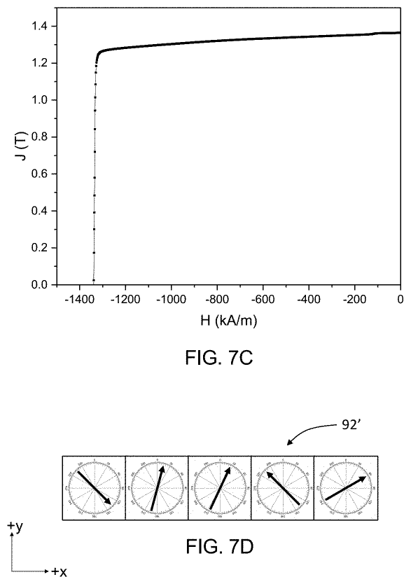

Referring now to FIG. 7A, a typical design of a variable flux electric machine 90 employing two conventional permanent magnet types 92, 94 is schematically depicted. The magnet 92 is of lower coercivity, and the magnet 94 has high coercivity. For both magnets 92, 94 the magnetization direction is fixed and normally perpendicular to the surface of the magnet as shown in FIG. 7B. It should be understood that low coercivity magnets are capable of being demagnetized to certain levels depending on machine operation. However, for conventional magnets the materials of manufacture are homogeneous. As such, the irreversible demagnetization portion a demagnetization curve for such materials is very steep as graphically depicted in FIG. 7C. Accordingly, it is difficult if not impossible to control the magnetic field of conventional magnets 92, 94 such that the magnet 92 and/or magnet 94 are demagnetized to a certain (e.g. specific) desired level. It should be understood that each magnet 92, 94 schematically depicted in FIG. 7A has a separate demagnetization curve.

Referring now to FIG. 7D, a magnet array 92′ according to the teachings of the present disclosure is schematically depicted. The magnet array 92′, which may be used to replace the magnets 92 and/or 94 in FIG. 7A has a defined magnetic inhomogeneity. Particularly, each segment of the array 92′ can be made of different materials or the same material with different orientations. The working point/permeance coefficient can also be modulated by varying dimensions of each segment or by adding soft magnetic materials such that the magnetic field required to demagnetize each part of the magnet array is differentiated and the demagnetization of the magnet array 92′ is calculated, designed, and predicted regardless of thermal and piece-to-piece variation issues.

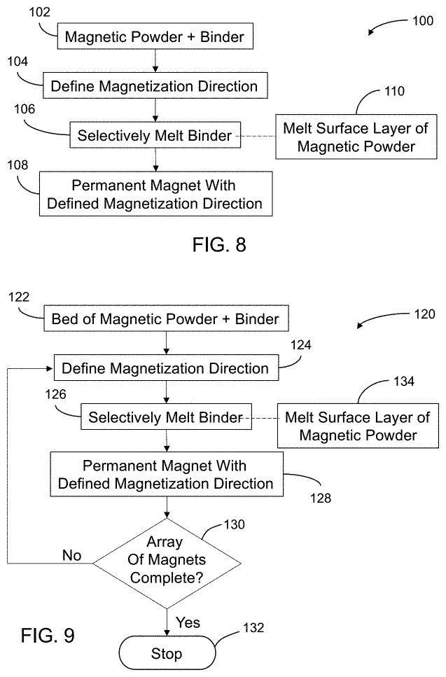

Referring now to FIG. 8, a method 100 of forming a magnet according to the teachings of the present disclosure is schematically depicted. Particularly, the method 100 includes disposing an anisotropic magnetic powder and a binder within a bed at step 102 and defining a magnetization direction of the anisotropic magnetic powder in the bed at step 104. At step 106 an energy beam selectively melts the binder such that a permanent magnet with the defined magnetization direction is provided at step 108. In some aspects of the present disclosure a surface layer of the anisotropic magnetic powder is melted at step 110 concurrently with and/or after step 106.

Referring now to FIG. 9, a method 120 of forming a magnet array is schematically depicted. The method 120 includes disposing an anisotropic magnetic powder and a binder within a bed at step 122 and defining a magnetization direction of the anisotropic magnetic powder in the bed at step 124. At step 126 an energy beam selectively melts the binder such that a permanent magnet with the defined magnetization direction is provided at step 128. In some aspects of the present disclosure a surface layer of the anisotropic magnetic powder is melted at step 134 concurrently with and/or after step 126. At step 130, the method 120 determines if forming the magnet array has been completed. If the magnet array has not been completed (‘No’), the method returns to step 124 and repeats steps 124, 126, 128, and optionally step 134, until the magnet array is completed. If the magnet array is complete (Yes), the method 120 stops at step 132.

In some aspects of the present disclosure, a post-processing heat treatment is employed to improve the properties (e.g., density, magnetic properties, etc.) of magnets or magnet arrays. For example, Nd—Fe—B magnets or magnet arrays can be heat treated (annealed) at temperatures between 500 to 800° C. in vacuum or protective atmosphere to enhance the magnetic performance.

According to the teachings of the present disclosure, issues related to the assembly of magnets, complicated magnetic shapes, magnetization direction of each magnet, material waste amongst other issues related to the manufacture of permanent magnet arrays are addressed. Particularly, methods of forming magnets and/or magnet arrays with customized shapes and magnetization directions are provided. The methods include aligning (defining) a magnetization direction for a plurality magnetic particles and selectively melting a binder material such that a magnetic particle—binder matrix composite layer is formed. A plurality of such layers is formed on top of and bonded to each other such that a permanent magnet with the defined magnetization direction is formed. Similarly, additional magnets are formed until a magnet array is provided. The plurality of magnets may be bonded together and/or assembled to form the magnet array. It should be understood that with the flexibility of 3D printing, a magnet formed according to the teachings of the present disclosure may contain different materials tailored to a desired configuration. Moreover, the magnetic powder may be the same throughout a given magnet and/or magnet array, but the distribution of the magnetic powder may be inhomogeneous according to the desired magnetic field and applications, thereby improving control over the generated magnetic field.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, examples that do not depart from the substance of the disclosure are intended to be within the scope of the disclosure. Such examples are not to be regarded as a departure from the spirit and scope of the disclosure. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method of forming a magnet comprising:
disposing an anisotropic magnetic powder and a binder within a bed, the anisotropic magnetic powder having a defined magnetization direction; and
operating an energy beam to selectively melt the binder such that the anisotropic magnetic powder forms a permanent magnet with the defined magnetization direction.

2. The method according to claim 1 further comprising melting a surface layer of the anisotropic magnetic powder to form the permanent magnet with the defined magnetization direction.

3. The method according to claim 1, wherein the energy beam is at least one of an electron beam, a laser beam, and a microwave beam.

4. The method according to claim 1, wherein the binder comprises a binder powder.

5. The method according to claim 1, wherein the binder comprises a binder layer disposed on the anisotropic magnetic powder.

6. The method according to claim 5, wherein the anisotropic magnetic powder and the binder in the bed comprise core-shell particles with the anisotropic magnetic powder coated with the binder.

7. The method according to claim 1, wherein an external magnetic field applied to the magnetic powder in the bed orients the magnetization direction of the anisotropic magnetic powder.

8. The method according to claim 7, wherein the defined magnetization direction is provided by applying at least one of a pulsating external magnetic field and a DC external magnetic field on the anisotropic magnetic powder and the binder within the bed.

9. The method according to claim 1 further comprising increasing the packing density of the anisotropic magnetic powder and the binder by sonicating, tapping or rolling the bed.

10. The method according to claim 1, wherein the binder is selected from at least one of an epoxy, a ceramic, and a metal alloy.

11. The method according to claim 10, wherein a melting point of the binder is less than 800° C.

12. The method according to claim 10, wherein the binder comprises a (Nd_{(1-x-y-z)}PrₓDy_{y}Tb_{z})ₐ(Cu_{(1-u-v-w)}(AlᵤZnᵥGa_{w})_{b}) alloy, a (CeₓLa₁₋ₓ)ₐ(Cu_{(1-u-v-w)}(AlᵤZnᵥGa_{w})_{b}), material, or a combination thereof, and ‘a’ is greater than ‘b’.

13. The method according to claim 12, wherein the anisotropic magnetic powder is a Nd—Fe—B magnetic powder.

14. The method according to claim 1, further comprising annealing the magnet between 500° C. and 800° C.

15. The method according to claim 1 further comprising forming a magnet array comprising a plurality of permanent magnets, wherein each of the plurality of permanent magnets has a unique defined magnetization direction different than the defined magnetization direction of the other permanent magnets.

16. An electric machine comprising the magnet array of claim 15.

17. A method of forming a plurality of permanent magnets comprising:
disposing an anisotropic magnetic powder and a binder within a bed, the anisotropic magnetic powder having a defined magnetization direction;
operating an energy beam to selectively melt the binder such that the anisotropic magnetic powder forms a permanent magnet with the defined magnetization direction; and
operating the energy beam to selectively melt the binder such that the anisotropic magnetic powder forms additional permanent magnets such that a magnet array is formed and each of the permanent magnets comprises a unique magnetization direction.

18. The method of claim 17, wherein operating the energy beam comprises a first scan to selectively melt the binder such that the anisotropic powders are held in a fixed position and a second scan to selectively melt a surface layer of the anisotropic magnetic powder.

19. A method of forming a magnet array comprising the steps of:
(a) aligning a magnetization direction of a plurality of anisotropic magnetic particles in an anisotropic powder-binder mixture;
(b) selectively melting a binder in the anisotropic powder-binder mixture using an energy beam such that the plurality of anisotropic magnetic particles is bonded together to form a permanent magnet with the magnetization direction; and
(c) repeating steps (a) and (b) such that a magnet array with a plurality of permanent magnets is formed, wherein each of the permanent magnets has a unique magnetization direction different than the magnetization direction of the other permanent magnets.

20. The method of claim 19, wherein the energy beam comprises a microwave beam and the microwave beam selectively melts the binder and a surface layer of the plurality of anisotropic magnetic particles in the anisotropic powder-binder mixture.
